(19) United States
(12) Patent Application Publication
(10) Pub. No.: US 2018/0045462 A1
(43) Pub. Date: Feb. 15, 2018

(54) ULTRASOUND AND INFRARED ASSISTED CONDUCTIVE HYDRO-DRYER

(71) Applicants: Vahid Baeghbali, Shiraz (IR); Mehrdad Niakousari, Shiraz (IR)

(72) Inventors: Vahid Baeghbali, Shiraz (IR); Mehrdad Niakousari, Shiraz (IR)

(21) Appl. No.: 15/789,742

(22) Filed: Oct. 20, 2017

(30) Foreign Application Priority Data
Dec. 11, 2016 (IR) 13955014000301140

(51) Int. Cl. F26B 3/22; F26B 15/10; A23L 3/40; F26B 3/30

(52) U.S. Cl. CPC F26B 3/22; F26B 3/30; F26B 15/105; A23L 3/40

(57) ABSTRACT

A method and system for drying food products is disclosed. The system includes an infrared source, an ultrasonic generator, and a hydro conductive dryer. Food products are placed on a moving conveyor belt that cycles through the system and exposes the food products to infrared and ultrasonic vibration while also transferring thermal energy from heated water to the food products.

### CROSS-REFERENCE TO RELATED APPLICATION

This application claims priority to Iranian Patent Application Serial Number 139550140003011402 field on Dec. 11, 2016, the content of which is incorporated herein by reference in its entirety.

### BACKGROUND

Food processing technology encompasses the transformation of raw ingredients, by physical or chemical means into food, or of food into other forms. Food processing combines raw food ingredients to produce marketable food products that can be easily prepared and served by the consumer. Food processing typically involves activities such as mincing and macerating, liquefaction, emulsification, and cooking, pickling, pasteurization, drying, and many other kinds of preservation, and canning or other packaging.

Food drying is a method of food preservation in which food is dried (dehydrated or desiccated). Drying inhibits the growth of bacteria, yeasts, and mold through the removal of water. Water is traditionally removed through evaporation (air drying, sun drying, smoking or wind drying).

### SUMMARY

This summary is intended to provide an overview of the subject matter of this patent, and is not intended to identify essential elements or key elements of the subject matter, nor is it intended to be used to determine the scope of the claimed implementations. The proper scope of this patent may be ascertained from the claims set forth below in view of the detailed description below and the drawings.

In one general aspect, the present disclosure is directed to a method of drying food products. The method includes placing a first moist food product onto a conveyor belt, the conveyor belt moving in a continuous loop through a housing, and moving the first moist food product into the housing, the housing comprising an infrared source, an ultrasonic vibration source, and a hydro conductive apparatus. Additional steps include irradiating the first moist food product, transferring thermal energy from heated water to the first moist food product, and exposing the first moist food product to ultrasonic vibration, thereby producing a first dried food product.

The above general aspect may include one or more of the following features. For example, placing the first moist food product onto a conveyor belt may further include spreading the first moist food product on the conveyor belt such that the first moist food product is irradiated in a substantially uniform manner. Another step can include adjusting an intensity of the irradiation by use of a control panel associated with the housing. The method can also include adjusting a temperature of the heated water by use of a control panel associated with the housing. In another aspect, the method includes adjusting an intensity of the ultrasonic vibration by use of a control panel associated with the housing. In some cases, the method comprises adjusting a speed of the moving conveyor belt to increase an exposure time of the first moist food product to the irradiation. In another example, the method includes removing the first dried food product from the conveyor belt using a doctor blade. Furthermore, the method can include placing a second moist food product onto the conveyor belt, moving the second moist food product into the housing, irradiating the second moist food product, exposing the second moist food product to ultrasonic vibration, and transferring thermal energy from heated water to the second moist food product, thereby producing a second dried food product. In another aspect, the method includes irradiating the first moist food product while transferring thermal energy from heated water to the first moist food product, and in yet another aspect, the method may include ultrasonically vibrating the first moist food product while transferring thermal energy from heated water to the first moist food product. The method can also include cooling the first dried food product. In another example, exposing the first moist food product to ultrasonic vibration may further include exposure to ultrasonic vibration through heated water underneath the conveyor belt.

In one general aspect, the present disclosure is directed to a dryer for production of dried food products. The dryer can include an infrared source, an ultrasonic generator, and a hydro conductive apparatus, and a conveyor belt.

The above general aspect may include one or more of the following features. For example, the ultrasonic generator can be mounted below a hot water tank of the hydro conductive apparatus. In another example, the hydro conductive apparatus is configured to provide a source of hot water that transfers thermal energy to food products placed in the dryer. Furthermore, in some cases, the conveyor belt comprises a strip of material that cycles through the dryer in a loop. The dryer can also include a first blade associated with a first end of the dryer and a second blade associated with a second end of the dryer. In addition, the housing can be disposed on a raised platform, and a lower interior cavity below the raised platform may be enclosed by a plurality of side covers. In another example, a first control panel configured to allow adjustments to drying speed, water temperature, conveyor belt speed, and infrared power may be included.

Other systems, methods, features and advantages of the implementations will be, or will become, apparent to one of ordinary skill in the art upon examination of the following figures and detailed description. It is intended that all such additional systems, methods, features and advantages be included within this description and this summary, be within the scope of the implementations, and be protected by the following claims.

### BRIEF DESCRIPTION OF THE DRAWINGS

The implementations can be better understood with reference to the following drawings and description. The components in the figures are not necessarily to scale, emphasis instead being placed upon illustrating the principles of the implementations. Moreover, in the figures, like reference numerals designate corresponding parts throughout the different views.

FIG. 1 depicts an implementation of an overview of an ultrasonic and infrared assisted conductive hydro dryer;

FIG. 2 depicts an isometric view of an implementation of a three-dimensional model of an ultrasonic and infrared assisted conductive hydro dryer with side covers;

FIG. 3 depicts a photograph of an implementation of a ultrasonic and infrared assisted conductive hydro dryer without side covers;

FIG. 4 is an isolated view of an implementation of ultrasonic transducers;

FIGS. 5A and 5B depict isolated views of an implementation of infrared lamps; and

FIG. 6 is a flow chart of an implementation of a drying process.

### DETAILED DESCRIPTION

In the following detailed description, various examples are presented to provide a thorough understanding of inventive concepts, and various aspects thereof that are set forth by this disclosure. However, upon reading the present disclosure, it may become apparent to persons of skill that various inventive concepts and aspects thereof may be practiced without one or more details shown in the examples. In other instances, well known procedures, operations and materials have been described at a relatively high-level, without detail, to avoid unnecessarily obscuring description of inventive concepts and aspects thereof.

The technology of food drying generally involves an operation where water is removed from products through application of heat, resulting in a substantially solid end product. The final product may be in the form of sheets, flakes, film, powder, or granules. The drying process is typically energy intensive and has been used in the food industry to provide microbial stability, reduce deteriorative chemical reactions, facilitate storage, and minimize transportation costs. There is a need for new drying techniques to improve energy consumption, product quality, safety, environmental impact, cost, and productivity.

Material processing involving conduction is advantageous because the heat transfer intensity can be very high (approximately ten times higher in comparison to a convective one), and directed variation of temperatures of the heat transport medium allows the migration of dissolved substances to improve the quality of processed material. Conductive hydro drying uses circulating hot water as a means to convey thermal energy to materials to be dehydrated.

In hydro conductive drying systems such as Refractance Window systems, thermal energy from hot water is transferred to wet material deposited as thin film on a plastic conveyor belt. Various aspects of the conventional Refractance Window system are described in Magoon, U.S. Pat. No. 4,631,837, issued Dec. 30, 1986, titled “Method and Apparatus for Drying Fruit Pulp and the Like”, the entirety of which is herein incorporated by reference, hereafter referred to as “Drying Fruit Pulp application”. In some cases, the conveyer belt moves while in contact with the hot water and can result in rapid continuous drying. The dry product can be scraped off of the conveyor using a blade that spans the full width of the belt. Unlike direct dryers, cross-contamination does not occur in indirect dryers such as the Refractance Window system because the product does not contact the heat transfer medium.

Implementations described herein may also utilize infrared heating or drying, which can involve a heat transfer by radiation between a hot element such as infrared lamps and a material at lower temperature that needs to be heated or dried. The peak wavelength of the radiation is dependent of the temperature of the heated element. Thermal radiation is considered to be infrared in the electromagnetic spectrum between the end of the visible, 0.78 μm, and 1000 μm. The heat energy can be transferred from the infrared source to the product to be heated without the need of an intermediate such as air or water. Materials will absorb, reflect and allow a fraction of the infrared spectrum to pass through. It is important to select the infrared emitters with the suitable spectra according to the type of product in order to optimize absorption of the radiation. In some implementations, the hot elements in an infrared system can include gas emitters or electrical lamps which are aligned in order to create a heating surface. Infrared emitters offer efficient heat and much more advantages compared to other conventional heat technologies.

Implementations described herein may also utilize ultrasound techniques. Ultrasound is a type of non-thermal method for food drying. Ultrasonic transducers can provide high frequency vibrations that can be applied to solid, liquid and gas systems for different purposes. Ultrasound technology can reduce processing time, save energy and improve the shelf life and quality of food products. In some cases, ultrasound can minimize flavor loss, improve homogeneity, and provide significant energy savings.

As will be discussed further below, ultrasound can be used for food preservation in combination with other treatments. Consumer demand for fresher, higher quality and microbiologically safe and stable food requires novel methods for ensuring a minimal degradation of food quality. The application of hydro convective heating and infrared and/or ultrasound may be more efficient over hydro convective heating alone, as it gives a synergistic effect. For example, the total energy required can be reduced as compared with convection drying alone. In some cases, a drying apparatus equipped with infrared heaters and/or ultrasonic heaters and a hydro conductive heating system can reduce economic costs, drying time, and operating temperature. Thus, the use of novel technologies, such as power ultrasound and infrared, can increase the drying rate and facilitate the drying of heat sensitive food materials.

In the following disclosure, an infrared and ultrasonic assisted hydro conductive drying process is introduced. An objective of the present disclosure is to present a novel process that increases the drying rate by bringing together ultrasound and infrared technology with conductive hydro drying technology in an energy efficient and streamlined system. Another objective is to describe the design and manufacture of a continuous dryer that provides infrared, ultrasonic, and hydro conductive food drying where the drying efficiency is substantially increased. The disclosed system can significantly increase the drying rate of moist materials that are in contact with the conveyor belt.

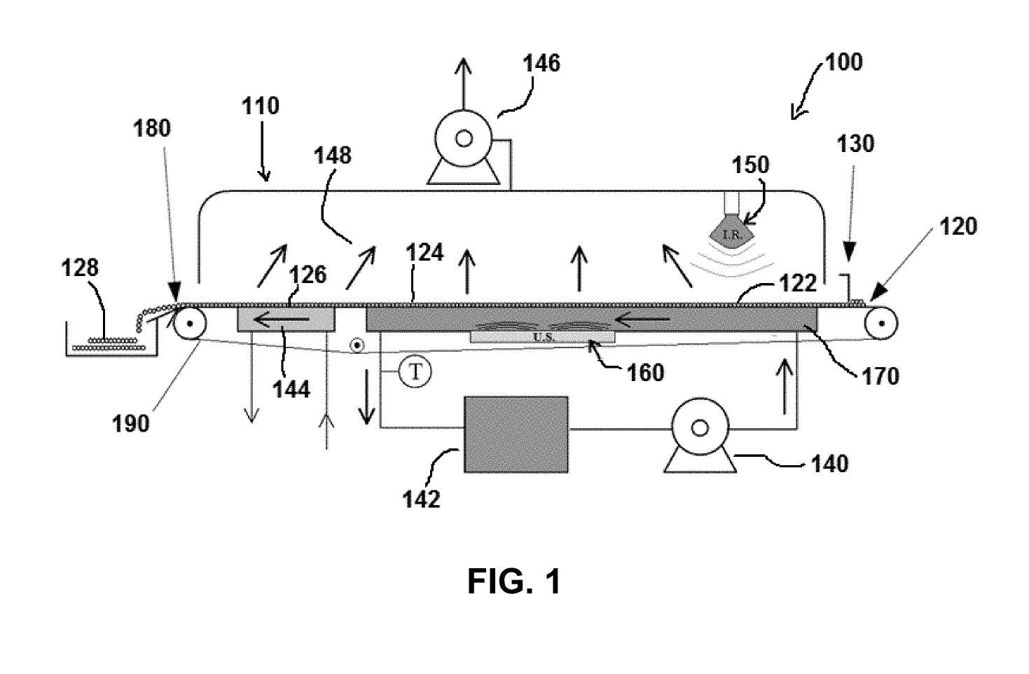

Referring now to FIG. 1, a schematic interior view of an implementation of a continuous ultrasound and infrared assisted conductive hydro dryer system (“system”) 100 is depicted. In different implementations, system 100 includes provisions for exposing an initial product to a series of drying technologies. In the implementation of FIG. 1, system 100 comprises one or more infrared sources (“infrared source”) 150, one or more ultrasonic sources (“ultrasonic source”) 160, such as ultrasonic transducers, and a hydro conductive system. In different implementations, the hydro conductive system can comprise various devices or components for transferring thermal energy from heated or hot water. For example, in FIG. 1, the hydro conductive system includes a hot water pump 140, a water heater 142, a hot water open tank 170 which can supply hot water to the system, a cooling water open tank 144, and/or an exhaust fan 146. The hydro conductive system can include any features, methods, devices, or components described in the Drying Fruit Pulp application. The hydro conductive can provide a source of hot water upon which the conveyor belt or continuous sheet can float. The thermal energy of the hot water can be used to dry moist materials that are in contact with the conveyor belt, and continue to cycle through the system in a substantially continuous manner.

In some implementations, system 100 can further include a first blade 130 near the front end of the system and a second blade 180 near the rear end of the system. The first blade 130 and second blade 180 can be adjustable or replaceable in different implementations. Furthermore, second blade 180 can comprise a doctor blade in one implementation. In addition, system 100 can include provisions for moving, transporting, or transferring products from one region of the system to another region. In FIG. 1, system 100 includes a conveyor belt 190. The conveyor belt 190 can include a strip of material that is looped to allow for continuous cycling through the system. The conveyor belt 190 can comprise Mylar or other materials as described in the Drying Fruit Pulp application.

In some implementations, system 100 can include a housing 110 that can contain, protect, or hold various components of system 100. The term “housing” as used throughout this detailed description and in the claims refers to any housing, enclosure, container or other structure that can be configured to store one or more devices, components and/or portions of the system.

For purposes of clarity to the reader, a general overview of the process of drying with reference to FIG. 1 is provided here. However, it should be understood that in other implementations the process can differ from that described here, and can include additional or alternate steps. In FIG. 1, it can be seen that an initial (not yet dried) product 120 is disposed on conveyor belt 190 at a first stage where products are added or placed into the system. For simplicity, products in FIG. 1 are represented schematically as a plurality of round or circular pieces. However, the product can comprise any type of material associated with food processing technologies. Initial product 120 moves along conveyor belt from the first stage to a second stage where initial product 120 can optionally be sliced, spread, parted or otherwise divided to provide system 100 with a substantially consistent, uniform and/or homogenous product for drying. The first stage and the second stage can be understood to comprise a pre-drying phase in one implementation.

As initial product 120 enters housing 110, the product moves through a series of stages in which drying of the product occurs (“drying phase”). During the drying phase, it can be understood that the product can undergo various processes associated with the hydro conductive process (see for example, Drying Fruit Pulp application). For example, the product passes through a series of regions in which thermal energy of hot water is transferred to the product. Water vapor 148 resulted from the product moisture evaporation is removed from interior of the housing, using the exhaust fan 146.

At the same time, in a third stage, initial product 120 is exposed to infrared radiation from infrared source 150, producing a radiated product 122. The infrared source 150 can comprise one or more lamps that can be mounted or attached to a top portion or cover of the housing 110 in one implementation. The infrared lamps can provide a type of instant, focused, immediate, or on-the-spot heating of the moist materials and can be used to accelerate the drying rate in the early stages of the overall drying phase.

After passing under infrared source 150, radiated product 122 moves to a fourth stage where it is exposed to ultrasonic vibrations from ultrasonic source 160, producing a radiated and sonicated product 124. The ultrasonic source 160 can be positioned or mounted under the hot water open tank 170 in some implementations. In different implementations, high power ultrasonic vibrations in a frequency range of 20-40 kHz can be applied to the product to increase heat and mass transfer in the drying process as well as accelerates the drying rate in the final stages of the drying process. Furthermore, water can be used for the transfer of the ultrasonic vibrations to the moist materials via the Mylar sheet or belt.

In a fifth stage, the product is dried using the hydro conductive techniques described herein. It should be understood that although the hydro conductive drying process is referred to as a fifth stage, the hydro conductive drying process may occur before, during, or after either the irradiation stage or the ultrasonication stage. For example, in one implementation, the hydro conduction can occur after irradiation and before ultrasonication. In another implementation, the hydro conduction can occur before irradiation, during irradiation, and/or after irradiation. Similarly, in some implementations, the hydro conduction can occur before ultrasonication, during ultrasonication, and/or after ultrasonication.

Thus, in some implementations, the hydro conductive process can be substantially continuous or ongoing as the product moves through the second stage to the fifth stage. In one implementation, the hydro conductive process occurs during the substantial entirety of the time in which the product is in the housing 110. In some implementations, the conductive drying process can occur throughout or substantially contemporaneous with either or both of the third stage and the fourth stage. In other words, while thermal energy from the heated water is transmitted to the product via water heater 142 and hot water pump 140, the product may also be exposed to infrared radiation and/or ultrasonic vibrations. For example, while the product is being irradiated, thermal energy from the heated water may also be applied to the product. Similarly, while the product is vibrated, thermal energy may also be applied to the product. This system provides a streamlined process for improving drying efficiency and decreasing energy costs.

In a sixth stage, the product can optionally be cooled over the cooling water open tank 144 to a cooled product 126. As cooled product 126 emerges or exits from housing 110, the drying phase may be understood to have been completed. In an optional seventh stage, a dried or final product 128 can be scraped or pulled off or otherwise removed with second blade 180, for example in flakes, sheets, or other dried portions.

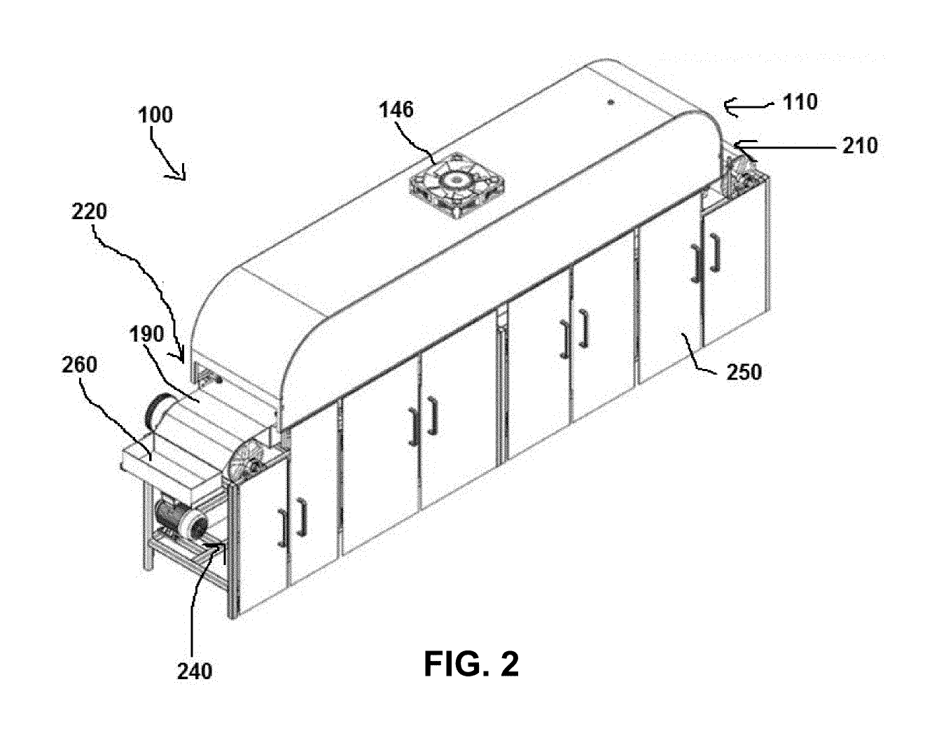

Referring now to FIG. 2, an isometric external view of an implementation of system 100 is depicted. In some implementations, system 100 includes main housing 110 that extends between a first end 210 and a second end 220. In some implementations, dried product can exit housing 110 and be dropped or received by a container 260. Furthermore, housing 110 can be disposed on a raised platform in some implementations, such that a lower interior cavity is provided below housing 110. The lower interior cavity can be at least partially surrounded or encased by a plurality of side covers 250 in some implementations, though in other implementations, there may be no side covers and the lower interior cavity may be generally exposed or open. Side covers 250 can protect or enclose various components disposed in the lower interior cavity, such as portions of the conveyor belt 190, the hot water pump 140, the water heater 142, and/or other mechanical or electrical components and machinery for the hydro conductive assembly or system, or the infrared or ultrasonic apparatuses. The side covers 250 can be removed, pulled open, or slid open in some cases, facilitating access to a user for maintenance or repair.

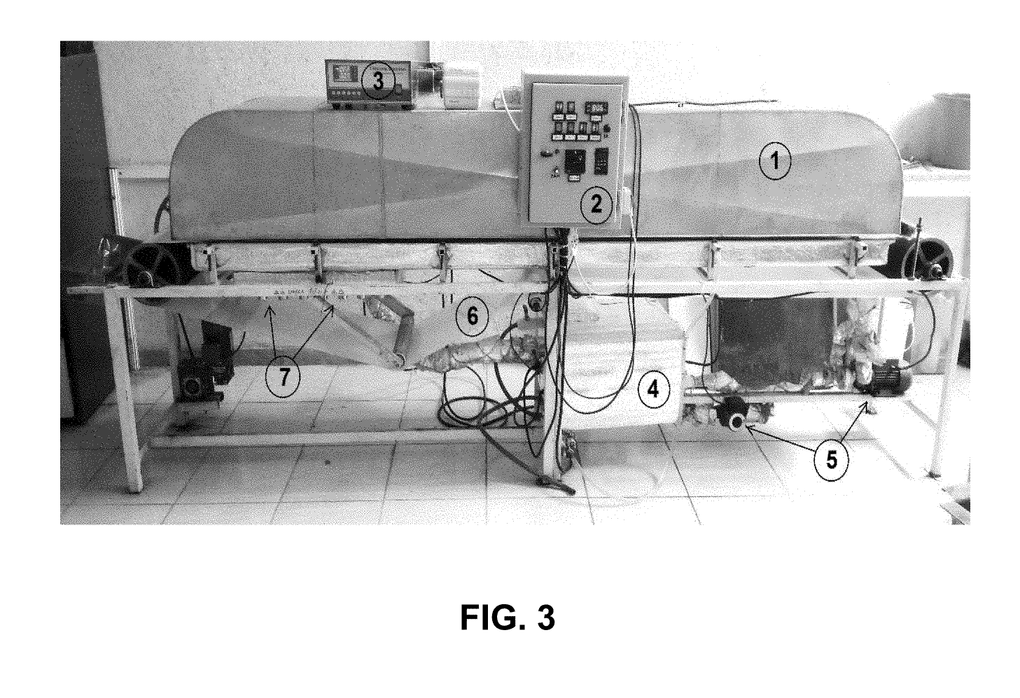

For purposes of clarity to the reader, in FIG. 3, a photograph of an implementation of a continuous ultrasound and infrared assisted conductive hydro dryer system is provided in which the side covers are not shown. As shown in FIG. 3, one implementation of the system includes at least an outer housing (1), a control panel (2), an ultrasonic generator (3), a water heater (4), hot water pumps (5), a conveyor belt (6), and ultrasonic transducers (7). In different implementations, features and conditions associated with water temperature, belt speed, infrared power, and/or fan speed and pumps may be controlled or adjusted using the control panel (2). The control panel (2) can comprise a plurality of switches, buttons, dials, and/or other adjustable devices. Furthermore, in other implementations the control panel (2) can include provisions for indicating the status of various portions of the system. For example, there may be a series of lights or a display that can indicate the activity levels, intensity, condition, functioning, error messages, and/or power status of various components of the system. Similarly, in one implementation, ultrasound power can be controlled or adjusted by the ultrasonic generator (3), which may be disposed atop of the housing (1) for ease of use, or in another readily accessible location.

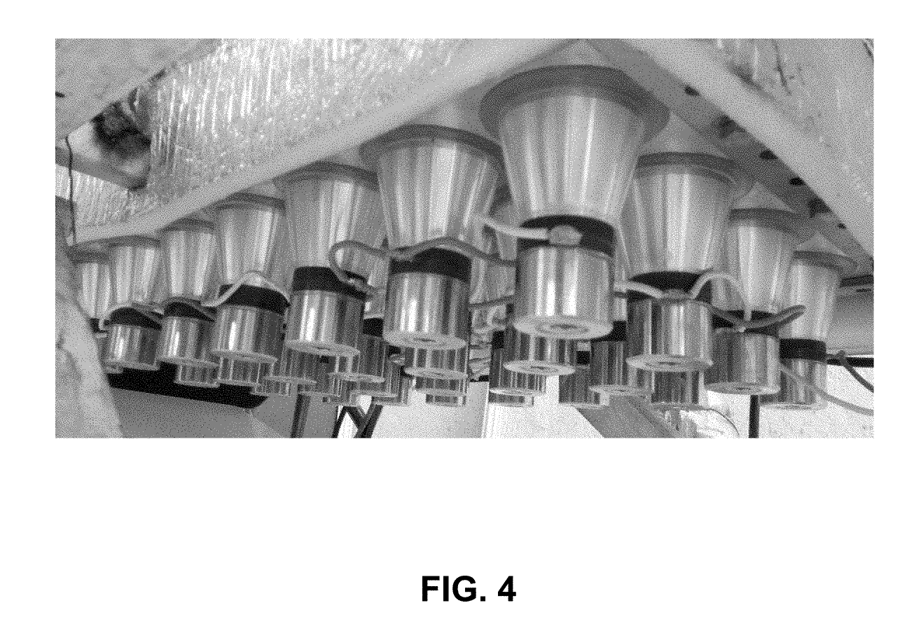

In order to provide greater detail to the reader, a photograph of an implementation of a series of ultrasonic transducers is presented in FIG. 4. In different implementations, the ultrasonic transducers can comprise a plurality of components that are attached or mounted along a surface of the system, such as the housing. In one implementation, the ultrasonic transducers are mounted above the hot water pump(s). The ultrasonic transducers can be arranged or positioned to provide the most effective vibrational effect to the hot water and/or the product. In some implementations, the ultrasonic transducers can be separated and re-mounted, facilitating the repair and/or replacement of the transducers. In other words, the ultrasonic transducers or portions thereof may be removably attached to the system. For purposes of this disclosure, the term “removably attached” or “removably inserted” shall refer to the joining of two components or a component and an element in a manner such that the two components are secured together, but may be readily detached from one another. Examples of removable attachment mechanisms may include hook and loop fasteners, friction fit connections, interference fit connections, threaded connectors, cam-locking connectors, compression of one material with another, and other such readily detachable connectors.

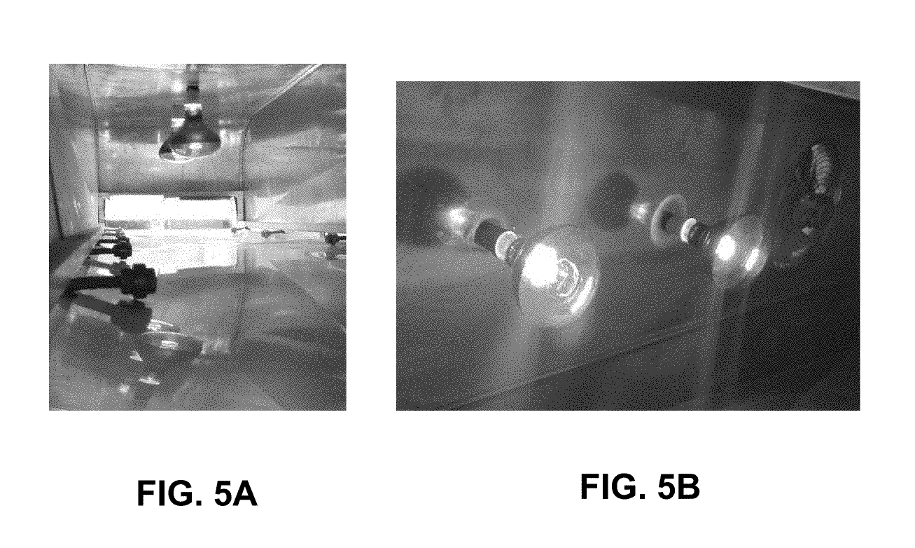

In order to provide greater detail to the reader, a photograph of an implementation of a series of infrared lamps is presented in FIGS. 5A and 5B. In different implementations, the infrared lamps can comprise a plurality of components that are attached or mounted along a surface of the housing. The lamps can be positioned above and/or along the side of the housing to provide optimal exposure to the products as they pass through the system. In some implementations, the infrared lamps can be separated and re-mounted, facilitating the repair and/or replacement of the infrared lamps. In other words, the infrared lamps or portions thereof may be removably attached to the system.

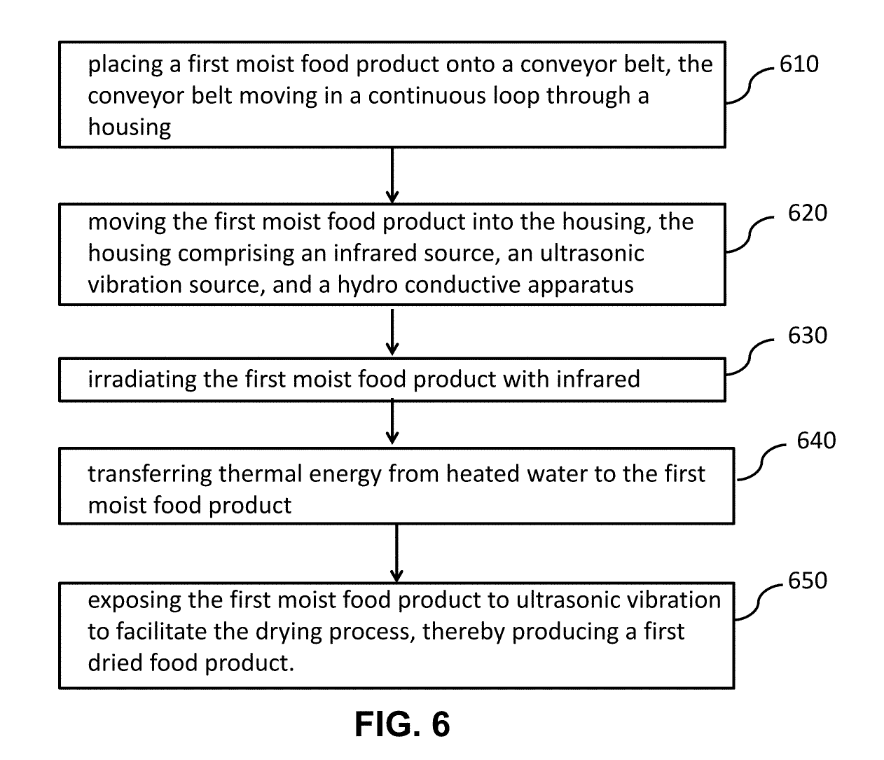

In FIG. 6, a flow chart is presented in which an implementation of a food drying method using the continuous ultrasound and infrared assisted conductive hydro dryer system is provided. As shown in FIG. 6, a first step 610 can involve placing or inserting a first moist food product onto a conveyor belt. In some implementations, the conveyor belt is configured to move in a continuous loop through the housing. A second step 620 includes moving the first moist food product into the housing. As described above, the housing can include or enclose at least some portions of an infrared source, an ultrasonic vibration source, and a hydro conductive apparatus. In a third step 630, the first moist food product can be irradiated by an infrared source, while a fourth step 640 involves transferring thermal energy from heated water to the first moist food product. In a fifth step 650 the first moist food product can be exposed to ultrasonic vibrations facilitating the drying process, thereby producing a first dried food product. In an optional sixth step, the end dried product is removed from the system. The cycle can be repeated in a substantially continuous fashion, and additional product can be inserted, dried, and removed from the system. In different implementations, the various settings associated with the system, such as water temperature, cycle speed, infrared intensity and duration, ultrasonic frequency and duration, exhaust fan speed and other conditions can be adjusted at any time through the control panel. It can be understood that the moisture level associated with the food product decreases as it passes through each stage. In other words, the hydro conductive stage provides a continuous drying process for the food product, reducing the moisture content of the food product. As the food product moves through the infrared radiation stage, the moisture level drops rapidly. Similarly, as the food product moves through the ultrasonic stage, the moisture level drops rapidly as well. Thus, the moisture content of the food product is far less after passing through all three stages relative to the moisture level of the food product after only being exposed to the hydro conductive process.

Thus, as presented herein, the drying process can provide for a system in which at least three drying technologies operate in conjunction with one another in a substantially automated and/or continuous manner. Conductive hydro drying utilizes the thermal energy of hot water to dry moist materials, but its drying speed is decreased by the increase of moist material thickness or by the reduction of hot water temperature. To overcome such limitations, infrared and ultrasound technologies are combined with conductive hydro drying. Infrared increases the drying rate at the early stages of the process and ultrasound vibrations increases the drying rate at the final stages of the drying process. In addition, the hot water temperature, conveyor belt speed, fan speed, infrared power and ultrasound power are each adjustable to achieve optimal conditions for each product type.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A method of drying food products comprising:
placing a first moist food product onto a conveyor belt, the conveyor belt moving in a continuous loop through a housing;
moving the first moist food product into the housing, the housing comprising an infrared source, an ultrasonic vibration source, and a hydro conductive apparatus;
irradiating the first moist food product with infrared;
exposing the first moist food product to ultrasonic vibration; and
transferring thermal energy from heated water to the first moist food product, thereby producing a first dried food product.

2. The method according to claim 1, further comprising spreading the first moist food product on the conveyor belt such that the first moist food product is irradiated in a substantially uniform manner.

3. The method according to claim 1, further comprising adjusting an intensity of the irradiation by use of a control panel associated with the housing.

4. The method according to claim 1, further comprising adjusting a temperature of the heated water by use of a control panel associated with the housing.

5. The method according to claim 1, further comprising adjusting an intensity of the ultrasonic vibration by use of a control panel associated with the housing.

6. The method according to claim 1, further comprising adjusting a speed of the moving conveyor belt to increase an exposure time of the first moist food product to the irradiation.

7. The method according to claim 1, further comprising removing the first dried food product from the conveyor belt using a doctor blade.

8. The method according to claim 1, further comprising:
placing a second moist food product onto the conveyor belt;
moving the second moist food product into the housing;
irradiating the second moist food product;
exposing the second moist food product to ultrasonic vibration; and
transferring thermal energy from heated water to the second moist food product, thereby producing a second dried food product.

9. The method according to claim 1, further comprising irradiating the first moist food product while transferring thermal energy from heated water to the first moist food product.

10. The method according to claim 9, further comprising ultrasonically vibrating the first moist food product while transferring thermal energy from heated water to the first moist food product.

11. The method according to claim 1, further comprising cooling the first moist food product.

12. The method according to claim 1, wherein the first moist food product is exposed to ultrasonic vibration through heated water underneath the conveyor belt.

13. A dryer for production of dried food products comprising:
an infrared source, an ultrasonic generator, and a hydro conductive apparatus; and
a conveyor belt.

14. The dryer of claim 13, wherein the ultrasonic generator is mounted below a hot water open tank of the hydro conductive apparatus.

15. The dryer of claim 13, wherein the conveyor belt comprises a strip of material that cycles through the dryer in a loop.

16. The dryer of claim 13, further comprising a first blade associated with a first end of the dryer and a second blade associated with a second end of the dryer.

17. The dryer of claim 13, further comprising a first control panel configured to allow adjustments to drying speed, water temperature, conveyor belt speed, exhaust fan speed and infrared power.
